(19) United States
(12) Patent Application Publication
(10) Pub. No.: US 2012/0074340 A1
(43) Pub. Date: Mar. 29, 2012

(54) HANDLE FOR GAS TANK VALVE

(76) Inventor: DOMINICK CAROLEI, Staten Island, NY (US)

(21) Appl. No.: 13/192,193

(22) Filed: Jul. 27, 2011

Related U.S. Application Data
(60) Provisional application No. 61/387,099, filed on Sep. 28, 2010.

(51) Int. Cl. F16K 31/60

(52) U.S. Cl. 251/213

(57) ABSTRACT

A device for operating a valve of a compressed-gas tank may include an engagement collar and operating handles attached to the collar. Notches may extend through a wall of the collar. The notches may be configured to engage with handle projections of the valve of the tank.

### RELATED APPLICATIONS

This application claims the benefit of U.S. Provisional Application No. 61387099 filed on Sep. 28, 2010.

### BACKGROUND OF THE INVENTION

The present invention generally relates to improved valve handles for compressed-gas tanks.

Compressed-gas tanks are typically provided with a valve that may be opened or closed with a rotatable handle. As shown in FIG. 1 (prior art), a typical tank 100 may be provided with a safety shield 102 that may surround a valve assembly 104. The valve 104 is usually operated manually. It may be seen that because the valve 104 is enclosed within the safety shield 102 a person must reach into the safety shield 102 to operate the valve 104. If the valve 104 is tightly closed, a person may injure his or her hand during an attempt to open the valve 104. This may occur if a person is exerting a large force on a handle of the valve 104. The person may strike his or her hand on the safety shield 102 when the handle turns unexpectently.

As can be seen, there is a need for a system for manually operating valves on compressed-gas tanks in a manner that precludes injury during such operation.

### SUMMARY OF THE INVENTION

In one aspect of the present invention, a device for operating a valve of a compressed-gas tank may comprise: an engagement collar; operating handles attached to the collar; and notches extending through a wall of the collar, the notches being configured to engage with handle projections of the valve of the tank.

In another aspect of the present invention, a method for operating a valve of a compressed-gas tank may comprise the steps of: placing a collar with notches over handle projections of the valve; and turning operating handles attached to the collar to apply force between the notches and the handle projections so that the valve is opened.

These and other features, aspects and advantages of the present invention will become better understood with reference to the following drawings, description and claims.

### BRIEF DESCRIPTION OF THE DRAWINGS

FIG. 1 is an elevation view of a compressed-gas tank in accordance with the prior art;

FIG. 2 is an elevation view of a compressed-gas tank adapted for operation with an extension device in accordance with an embodiment of the invention; and

FIGS. 3 through 6 are perspective views of the extension device of FIG. 2 in accordance with an embodiment of the invention.

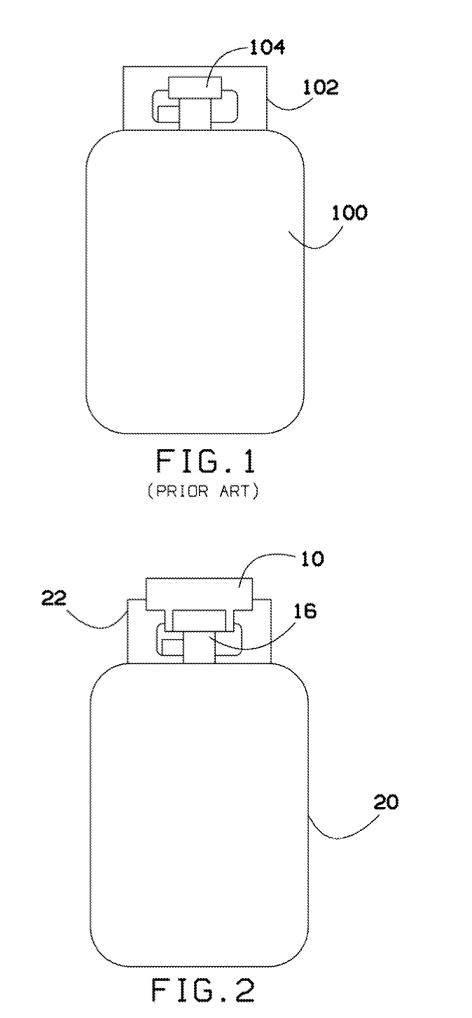

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide detachable extension devices that may be positioned on a valve assembly of a compressed-gas tank. The extension device may project above a safety shield of the tank.

Referring now to FIG. 2, it may be seen that in an exemplary embodiment, an extension device 10 may be placed on a valve 16 of a compressed-gas tank 20. Portions of the device 10 may be positioned above and outside of a safety shield 22 when the device 10 is placed on the valve 16.

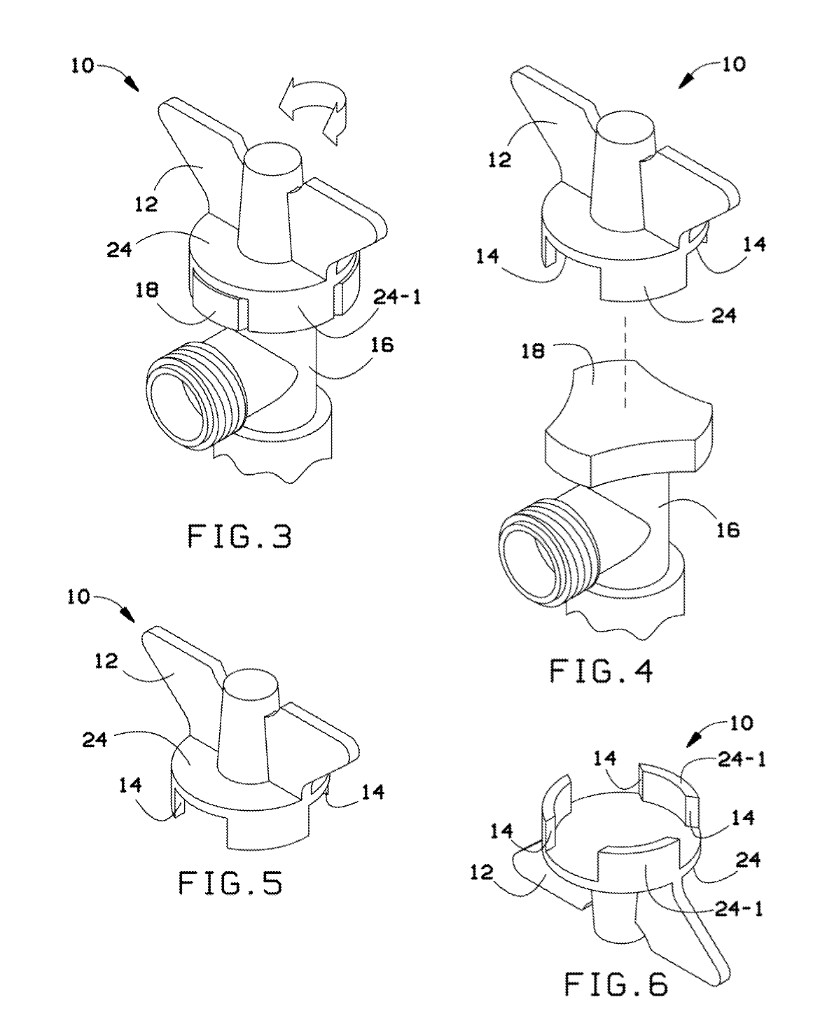

Referring now to FIGS. 3 through 6, it may be seen that an exemplary embodiment of the device 10 may comprise an engagement collar 24 and operating handles 12. The collar 24 and the operating handles 12 may be made from plastic (e.g. polyvinyl chloride). The collar 24 may have a cylindrical wall 24-1. Notches 14 may be provided in the wall 24-1. The notches 14 may be configured and positioned so that handle projections 18 of the valve 16 may pass through the notches 14 when the collar 24 is positioned on the valve 16.

The operating handles 12 may have an axial height large enough so that portions of the handles 12 may extend beyond the safety shield 22 of the tank 20 when the device 10 is in position on the valve 16. Consequently, a person may grasp the handles 12 and exert turning force to open the valve 16 without concern about striking his or her hand on the safety shield 22. It may be noted that the handles 12 may have a radial length longer than that of the handle projections 18 of the valve 16. Consequently, a person applying turning force to the device 10 may be provided with advantageous leverage during opening of the valve 16.

It may also be noted that the device 10 may be engaged with the valve 16 merely by sliding the device over the projections 18. The device 10 may be operational without using any securing devices such as screws or clamps. In this regard, the device 10 does not diminish safety aspects of the tank 20 having its valve 16 positioned within the confines of the safety shield 22. The purpose of the safety shield 22 is to block any accidental collision force from breaking the valve and allowing uncontrolled release of gas from the tank 20. In the event of such an accidental collision, the device 10, even though projecting above the safety shield, would merely be knocked away from the valve 16.

While the device 10 may be configured for use on many different valves of compressed-gas tanks, the device 10 illustrated in FIGS. 3 through 6 may be particularly useful for application on propane tanks of the type used for residential outdoor grills. In that regard the device 10 may comprise three of the notches 14 and a collective circumferential length of the notches 14 may be equal to about one half of a circumferential length of the cylindrical wall 24-1.

It should be understood, of course, that the foregoing relates to exemplary embodiments of the invention and that modifications may be made without departing from the spirit and scope of the invention as set forth in the following claims.

What is claimed is:

1. A device for operating a valve of a compressed-gas tank comprising:
an engagement collar;
operating handles attached to the collar; and
notches extending through a wall of the collar, the notches being configured to engage with handle projections of the valve of the tank.

2. The device of claim 1 wherein the engagement collar is cylindrical.

3. The device of claim 2 comprising three of the notches.

4. The device of claim 3 wherein a collective circumferential length of the notches is equal to about one half of a circumferential length of the cylindrical wall.

5. The device of claim 1 wherein the operating handles have a radial length that is greater than a radial length of the handle projections of the valve of the tank.

6. The device of claim 1 wherein an axial height of the operating handles is greater than a distance between a top of the valve and a top of a safety shield of the tank whereby at least portions of the operating handles project above the safety shield when the device is engaged with the valve.

7. The device of claim 1 wherein the collar and the operating handles are plastic.

8. The device of claim 7 wherein the plastic is polyvinyl chloride

9. A method for operating a valve of a compressed-gas tank comprising the steps of:
placing a collar with notches over handle projections of the valve; and
turning operating handles attached to the collar to apply force between the notches and the handle projections so that the valve is opened.

10. The method of claim 9 wherein the step of placing the collar results in positioning a portion of the operating handles above and outside of a safety shield of the tank.
